(19) United States
(12) Patent Application Publication
(10) Pub. No.: US 2018/0176998 A1
(43) Pub. Date: Jun. 21, 2018

(54) EVALUATING ZERO-VOLTAGE SWITCHING CONDITION OF QUASI-RESONANT INVERTERS IN INDUCTION COOKTOPS

(71) Applicant: Haier US Appliance Solutions, Inc., Wilmington, DE (US)

(72) Inventors: Isaac Nam, Louisville, KY (US); Meher Prasadu Kollipara, Louisville, KY (US); Victoria Steele, Louisville, KY (US)

(21) Appl. No.: 15/379,566

(22) Filed: Dec. 15, 2016

(51) Int. Cl. H05B 6/06; H05B 6/12

(52) U.S. Cl. CPC H05B 6/062; H05B 6/1236

(57) ABSTRACT

Systems and methods of quasi-resonant induction heating are provided. In particular, a method for evaluating a switching duration for zero-voltage switching of a quasi-resonant inverter in an induction cooktop can be provided. The quasi-resonant inverter can include a power supply circuit configured to supply a power signal to the induction heating coil. The quasi-resonant inverter can further include an induction heating coil configured to inductively heat a load with a magnetic field, a resonant capacitor connected to the induction heating coil and one or more switching elements.

### FIELD

The present subject matter relates generally to induction cooktops.

### BACKGROUND

Induction cooking appliances are more efficient, have greater temperature control precision and provide more uniform cooking than other conventional cooking appliances. In conventional cooktop systems, an electric or gas heat source is used to heat cookware in contact with the heat source. This type of cooking can be inefficient because only the portion of the cookware in contact with the heat source is directly heated. The rest of the cookware is heated through conduction that causes non-uniform cooking throughout the cookware. Heating through conduction takes an extended period of time to reach a desired temperature.

In contrast, induction cooking systems use electromagnetism which turns cookware of the appropriate material into a heat source. A power supply provides a signal having a frequency to the induction coil. When the coil is activated, a magnetic field is produced which induces a current on the bottom surface of the cookware. The induced current on the bottom surface then induces even smaller currents (e.g., eddy currents) within the cookware thereby providing heat throughout the cookware.

### BRIEF DESCRIPTION

Aspects and advantages of embodiments of the present disclosure will be set forth in part in the following description, or may be learned from the description, or may be learned through practice of the embodiments.

One example aspect of the present disclosure is directed to a method for evaluating the necessary switch-on duration for making zero-voltage switching of a quasi-resonant inverter in an induction cooktop possible. The method includes providing a pulse to turn a switching element associated with the quasi-resonant inverter in an induction cooktop on and off for a switch-on duration and a switch-off duration. The method includes determining a peak voltage across the switching element during the switch-off duration. The method further includes determining whether the peak voltage across the switching element is greater than a threshold for the switch-off duration. The method further includes when the peak voltage across the switching element is greater than the threshold, determining that the switch-on duration is sufficient for zero-voltage switching of the switching element associated with the quasi-resonant inverter.

Another example aspect of the present disclosure is directed to a control system for evaluating a zero-voltage switching condition of a quasi-resonant inverter in an induction cooktop. The control system can be configured to perform operations. The operations can include providing a pulse to turn a switching element associated with the quasi-resonant inverter in an induction cooktop on and off for a switch-on duration and a switch-off duration. The operations include determining a peak voltage across the switching element for the switch-off duration. The operations further include determining whether the peak voltage across the switching element is greater than a threshold. The operations further include when the peak voltage across the switching element is greater than the threshold, setting the switch-on duration as the minimum switch-on duration required for zero-voltage switching of the switching element associated with the quasi-resonant inverter.

Yet another example aspect of the present disclosure is directed to a quasi-resonant inverter for use in an induction cooktop. The quasi-resonant inverter includes a power source configured to supply power to the induction cooktop. The quasi-resonant inverter further includes an induction heating coil configured to inductively heat a load with a magnetic field. The quasi-resonant inverter includes a capacitor coupled with the induction heating coil. The quasi-resonant inverter includes a switching element. The quasi-resonant inverter further includes one or more control devices associated with the quasi-resonant inverter. The one or more control devices can be configured to perform operations. The operations include providing a pulse to turn a switching element associated with the quasi-resonant inverter in an induction cooktop on and off for a switch-on duration and a switch-off duration. The operations include determining a peak voltage across the switching element in the switch-off duration. The operations include determining whether the peak voltage across the switching element is greater than a threshold. The operations further include determining that the switch-on duration is sufficient for zero-voltage switching of the switching element associated with the quasi-resonant inverter when the peak voltage across the switching element is greater than the threshold.

Variations and modifications can be made to these example aspects of the present disclosure. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example induction cooktop appliance according to example embodiments of the present disclosure.

FIG. 2 depicts a circuit diagram of an example quasi-resonant inverter for use in an induction heating system according to example embodiments of the present disclosure.

FIG. 3 depicts a block diagram of an induction cooking system according to example embodiments of the present disclosure.

FIG. 4 depicts a flow chart of an example method of controlling an induction cooking system according to an example embodiment of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Example aspects of the present disclosure are directed to quasi-resonant (QR) induction cooktops. When operating QR cooktops, it can be beneficial for QR inverters to operate with zero-voltage switching (ZVS). For QR inverter topology in induction cooktops, effective load can vary due to different types of pans and pots placed on the cooktop. One of the challenges can be to estimate a minimum duration in which inverter switch should turn on before turning off so that ZVS can occur. Since the minimum switch-on duration required for ZVS can vary depending on the effective load, it can be advantageous to obtain an estimation method for ZVS to occur.

According to example embodiments of the present disclosure, minimum switch-on duration required for achieving ZVS can be estimated. For example, an example method can involve sending a pulse to turn a switching element on and off for a switch-on duration and a switch-off duration. During the switch-off duration, the example method can include measuring a peak voltage across the switching element and determining how much higher the peak voltage across the switching element is compared to a threshold. Based on how much higher the peak voltage is compared to a threshold, the example method can include determining whether the switch-on duration is sufficient for achieving zero-voltage switching of the switching element associated with the quasi-resonant inverter.

In this way, example aspects of the present disclosure can provide a number of technical effects and benefits. As will be understood by those skilled in the art, having a method for estimating minimum switch-on duration required for ZVS can be advantageous to other techniques in which switch-on duration needs to be longer than the minimum on-time required for making ZVS possible. As a result, a method of estimating minimum switch-on duration for ZVS can help reduce electromagnetic interference (EMI), conduction loss of anti-parallel diode, switch voltage stress, switch conduction loss, and switching loss during turn-on transition.

Referring now to the figures, example aspects of the present disclosure will be discussed in greater detail.

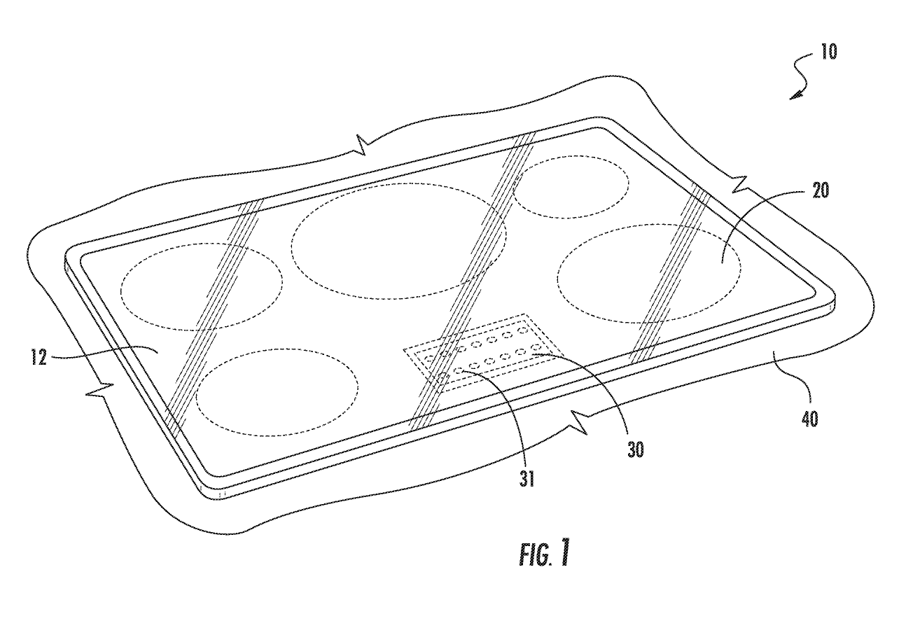

FIG. 1 depicts induction cooktop 10 according to example embodiments of the present disclosure. Cooktop 10 can be installed in chassis 40 and in various configurations such as cabinetry in a kitchen, coupled with one or more ovens or as a stand-alone appliance. Chassis 40 can be grounded. Cooktop 10 includes a horizontal surface 12 that can be glass or other suitable material. Induction coil 20 can be provided below horizontal surface 12. It can be understood that cooktop 10 can include a single induction coil or a plurality of induction coils.

Cooktop 10 is provided by way of example only. The present disclosure can be used with other configurations. For example, a cooktop having one or more induction coils in combination with one or more electric or gas burner assemblies. In addition, the present disclosure can be used with a cooktop having a different number and/or positions of burners.

A user interface can have various configurations and controls can be mounted in other configurations and locations other than as shown in the embodiment. In the illustrated embodiment, the user interface 30 can be located within a portion of the horizontal surface 30, as shown. Alternatively, the user interface can be positioned on vertical surface near a front side of the cooktop 10 or other suitable location. The user interface 30 can include, for instance, a capacitive touch screen input device component 31. The input component 31 can allow for the selective activation, adjustment or control of any or all induction coils 20 as well as any timer features or other user adjustable inputs. One or more of a variety of electrical, mechanical or electro-mechanical input device including rotary dials, push buttons, and touch pads can also be used singularly or in combination with the capacitive touch screen input device component 31. The user interface 30 can include a display component, such as a digital or analog display device designed to provide operation feedback to a user.

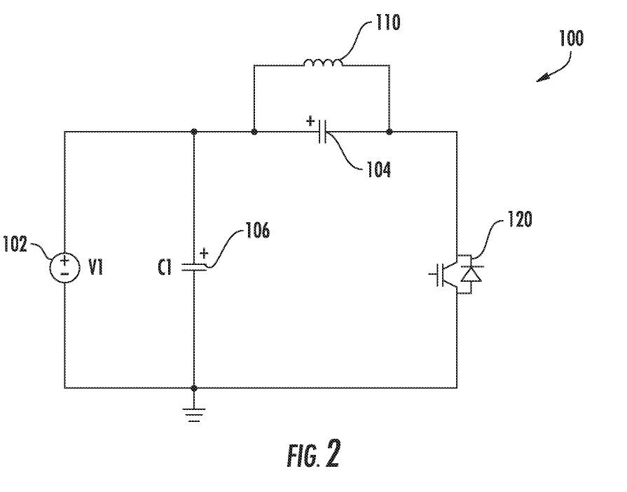

FIG. 2 depicts a circuit diagram of quasi-resonant inverter 100 for use in an induction heating system according to example embodiments of the present disclosure. Inverter 100 can include induction coil 110 and resonant capacitor 104. In particular, induction heating coil 110 and resonant capacitor 104 can correspond to a resonant tank circuit. Induction coil 110 can be configured to receive power signals from rectified alternating current (AC) source 102. Alternatively, any other power source can be used. For instance a one phase 260V power supply, a three phase power supply, a generator, a battery, and/or any direct current (DC) power source.

When a power signal is provided to induction coil 110, a varying or alternating magnetic field can be produced in induction coil 110. Induction coil 110 can include any configuration or material capable of creating a magnetic field that can produce eddy currents within a cookware utensil. For instance, induction coil 110 can include windings in horizontal direction, a vertical direction, or a combination of horizontal and vertical direction. Magnetic core materials such as but not limited to ferrite can be placed near induction coil 110.

Inverter 100 further includes switching element 120. Switching element 120 can be IGBT, MOSFET, BJT, or any other suitable switching element. It will be appreciated that inverter 100 can include more switching elements, such as two switching elements, three switching elements, etc. In an implementation, switching element 120 can have IGBT with a diode connected in anti-parallel configuration. Switching element 120 can control operation of the inverter such that current through induction coil 110 is controlled to have different shapes at different frequencies and different magnitudes. In particular, switching element 120 can receive control commands from one or more control devices, such as one or more gate drivers or other control devices. For instances, control commands can be determined based at least in part on one or more switching control signals provided from a control device. In some implementations, switching element 120 can receive control signals from an independent control device. The control signals can cause switching element 120 to turn on or off during one or more time periods, such that induction heating coil 110 produces a desired amount of output power. In some implementations, switching element 120 can be turned on and off in a manner such that inverter 100 is operated at a desired operating frequency.

Inverter 100 can be controlled to operate in a plurality of charging phases wherein induction heating coil 110 stores energy, and in a plurality of resonant phases wherein energy stored during the previous charging phases oscillates between induction heating coil 110 and resonant capacitor 104 to generate an alternating current signal. The charging phases can approximately correspond to the timer periods wherein the switching element is turned on. The resonant phases can approximately correspond to the periods of time wherein the switching element is turned off. In this manner, inverter 100 can be controlled such that current flows through switching element 120 during a first subset of charging phases, and not during a second subset of charging phases.

For instance, during a first charging phase of inverter 100, switching element 120 can be turned on (e.g., by applying sufficient gate voltage to switching element 120) during a first time period to allow induction heating coil 110 to charge to a sufficient level. Switching element 120 can then be turned off to allow the energy stored in induction heating coil 110 during the first charging phase to oscillate (e.g., during a first resonant phase of inverter 100) between induction heating coil 110 and resonant capacitor 104, such that an alternating current signal is produced. During the switch-off duration, the alternating current signal can cause sinusoidal voltage oscillation across switching element 120 such that the voltage oscillation is underdamped enough to reach zero.

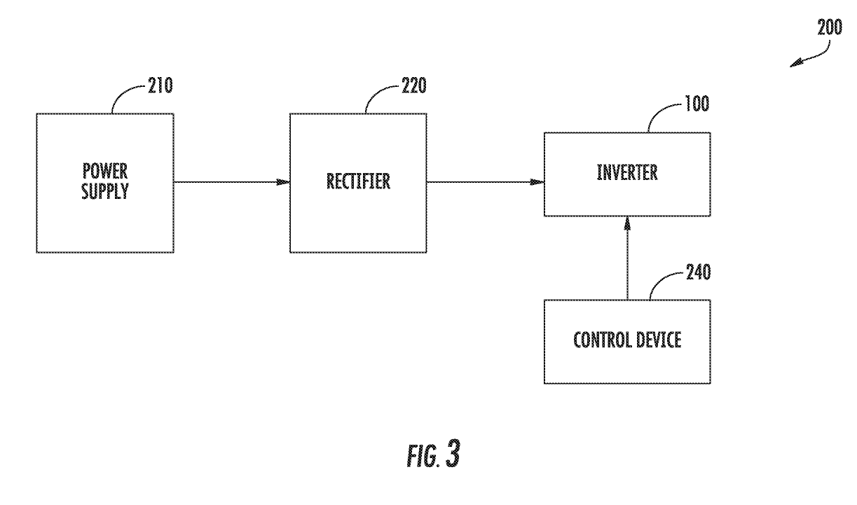

FIG. 3 depicts a block diagram of an induction cooking system 200 according to example embodiments of the present disclosure. System 200 can include a power supply 210, a rectifier 220, an inverter 100, and a control device 240.

Power supply 210 can be configured to supply power to the cooking appliance. Generally, power supply 210 can be a two phase, 240 volt alternating current (AC) power supply that is provided to a residential property from an energy production source such as an electric utility. Alternatively, any other power source can be used. For instance, a one phase 120V power supply, a three phase power supply, a generator, a battery, and/or any DC power source.

Rectifier 220 is coupled between power supply 210 and inverter 100. When an AC power supply signal is provided, rectifier 220 can convert the AC power signal into a rectified signal. This rectified signal is input to inverter 100. Rectifier 220 can include various configurations and devices. For example, the rectifier can be a diode full-bridge for full-wave rectification or a synchronous rectifier with a plurality of switching elements for active rectification.

Inverter 100 can be coupled to rectifier 220. Inverter 100 can be used to convert the rectified signal provided from rectifier 220 into high-frequency, high current signal to induction coil 110 to generate magnetic field for induction heating used for cooking. Inverter 100 can include switching elements, diodes, capacitors, inductors and/or control devices. Any type of inverter that uses one or more IGBTs or any other switching devices can be used. For instances, a quasi-resonant inverter, a half-bridge inverter or a full-bridge inverter can be employed.

Inverter 100 can include switching element 120. Switching element 120 can receive pulses from one or more devices, such as one or more gate drivers. A gate driver can receive control commands from a micro-controller to provide pulses at different frequencies and different pulse-widths. For instance, the control commands can be determined based at least in part on one or more switching control signals from control device 240. The control signals from control device 240 can cause switching element 120 to turn on or off during one or more time periods, such that induction heating coil 110 produces a desired amount of output power.

In some implementations, operation of the switching element can be controlled using various suitable techniques, such as ZVS. In this manner, the gate drivers can initiate gate pulses in accordance with such control techniques (e.g., at zero crossing event). In a practical sense, ZVS can refer to switching transitions occurring at a voltage of value less than 1% of the absolute value of peak voltage across the switch. For example, if the peak is 1200 V, then switching transition at the switch voltage (Vsw) within the range −12 V<V_{SW}<+12 V can be considered practical ZVS. The gate pulses can cause the corresponding switching element to “turn-on,” with such practical ZVS causing the switching element to conduct current with reduction in both switching losses and EMI. In some implementations, the length of the gate pulses can be determined based at least in part on a current through the inductor of the resonant circuit.

Control device 240 can be positioned in any location within the induction cooktop appliance. For instance, control device 240 can be located under or next to the user interface 30 or otherwise below the horizontal surface 12. Various input/output (I/O) signals can be routed between the control device and various operational components of the appliance, such as user interface 30, inverter 230, induction coil 110, a display, sensor(s), alarms, and/or other components. In addition, control device 240 can be the only control device of the induction cooktop appliance or it could alternatively be a sub-controller coupled with the overall appliance controller. If control device 240 is a sub-controller, it can be located with the overall appliance controller or be separate from the overall appliance controller.

By way of example, any/all of the “control devices/controllers” discussed in this disclosure can include a memory and one or more processing devices such as micro-controllers, CPUs or the like, such as general or special purpose microprocessors operable to execute programming instructions or micro-control code associated with operation of an induction cooktop appliance 10. The memory can represent random access memory such as DRAM, or read only memory such as ROM or FLASH. In one embodiment, the processor executes programming instructions stored in memory. The memory can be a separate component from the processor or can be included onboard within the processor. Alternatively, the control device might also be constructed without using a microprocessor, using a combination of discrete analog and/or digital logic circuitry (such as switches, amplifiers, integrators, comparators, flip-flops, AND gates, and the like) to perform control functionality instead of relying upon software.

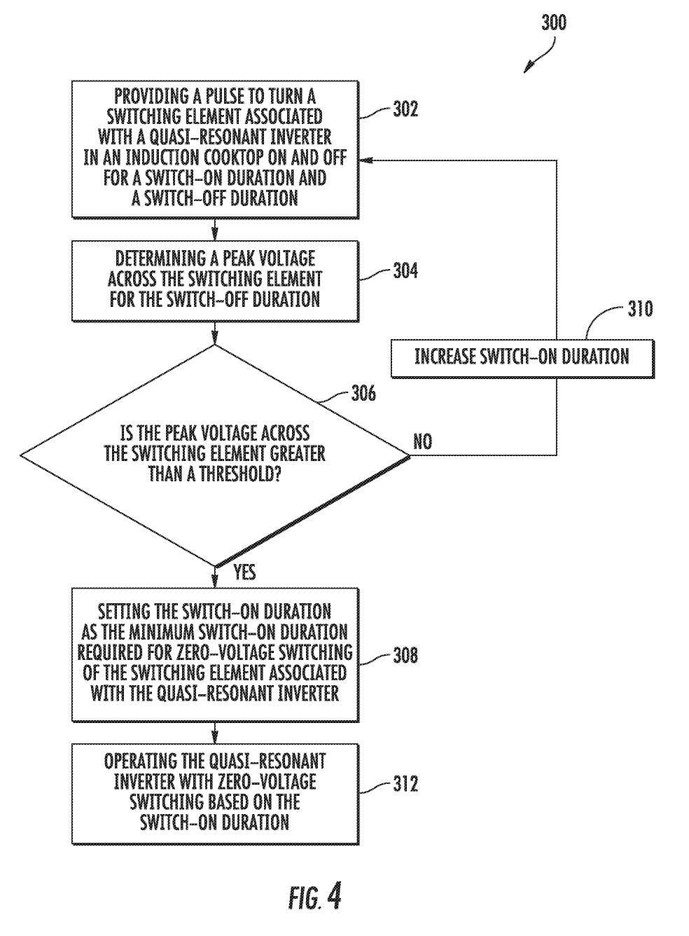

FIG. 4 provides a flow chart of method 300 according to example embodiments of the present disclosure. Method 300 can be performed by control device 240 or by separate devices. FIG. 4 depicts a method performed in a particular order for purposes of illustration and discussion. Those of ordinary skill in the art, using the disclosures provided herein, will understand that the methods discussed herein can be adapted, rearranged, expanded, omitted, or modified in various ways without deviating from the scope of the present disclosure.

At (302) a pulse can be provided to turn a switching element associated with a quasi-resonant inverter in an induction cooktop on and off for a switch-on duration and a switch-off duration. Initially, switch-on duration can be selected arbitrarily. The pulse can be a control command from one or more control devices such as one or more gate drivers or other control devices. The pulse can cause the corresponding switching element to “turn on,” causing the switching element to conduct current and then cause the switching element to “turn off,” causing a sinusoidal voltage oscillation with a DC offset to occur across the switching element. The pulse width can correspond to the switch-on duration.

At (304) a peak voltage of the sinusoidal voltage oscillation with a DC offset can be measured. For instance, the control device can obtain signals from a voltage sensor configured to sense the voltage across the switching element.

At (306) the peak voltage across the switching element is compared to a threshold to determine if it is greater than the threshold. The threshold can be determined based at least in part on a ratio of the peak voltage across the switching element to the supply voltage. For example, the threshold can be determined to be about 2.6 times the supply voltage. As used herein, the term “about,” when used in reference to a numerical value is intended to refer to within 30% of the numerical value.

For theoretically advantageous zero voltage switching to occur, the following condition needs to be satisfied:

$${V}_{SW} ( {nT}_{O} ) = 0 = \frac{{dV}_{SW} ( t )}{dt} {\vert}_{t = {nT}_{O}}$$

where V_{SW} is the voltage across the switching element of the quasi-resonant inverter, and T₀ is a resonant period associated with the resonant tank. The resonant period is the inverse of the resonant frequency that can be determined by capacitance and parasitic resistance of capacitor 104 and reflected inductance and resistance of induction coil 110 when a cookware (pan, pot, etc.) is placed on the induction coil. The resistance of induction coil 110 includes parasitic resistance and reflected load resistance. Those skilled in the art can decide whether to include all or some of these parameters in determining the resonant frequency. The parameter n is a fraction (e.g., 0.75) for defining, with respect to the resonant period duration, the time at which the first minimum voltage of the sinusoidal voltage oscillation with a DC offset occurs after the peak voltage of the sinusoidal voltage oscillation with a DC offset has occurred within the switch-off duration.

Since there is no unique solution for exact value of n that satisfies the above condition, a reasonable boundary for n needs to be defined. Within this boundary, a reasonable maximum value of n needs to be defined so that a reasonable minimum value for ratio nᵥ of the peak switch voltage to the supply voltage can be selected. With a reasonable minimum value of nᵥ, an example method for determining whether practical ZVS can occur can be if the peak voltage of the sinusoidal voltage oscillation with a DC offset is greater than or equal to nᵥ times the initial supply voltage, practical ZVS can occur, otherwise hard-switching can occur undesirably. Mathematically, as the maximum value of n approaches 1, nᵥ approaches 2. n and nᵥ approach 1 and 2 respectively when the following two conditions are met:
1. Quality factor (Q) approaches ∞;
2. Initial coil current in the quasi-resonant inverter approaches 0.
   Since the two conditions above are not practically possible, nᵥ≈2 is not a practical minimum threshold for ZVS.

Table 1 below shows the approximated possible values for nᵥ corresponding to the different approximated values of n.

TABLE 1

| n | nᵥ |
|---|---|
| ≈0.75 | ≈3.4 |
| ≈0.80 | ≈2.6 |
| ≈0.82 | ≈2.5 |
| ≈0.84 | ≈2.3 |

In conventional cooktop applications, n is less than 0.8 in steady-state operation of the quasi-resonant inverter. That is, the switch-off duration is less than 0.8 times the resonant period.

In conventional induction cooktop applications, 2.6 can be selected for minimum value of nᵥ. If the peak voltage of the sinusoidal voltage oscillation with a DC offset, which is measured in the switch-off duration, is not greater than 2.6 times the initial supply voltage, which is measured before the switching element is turned on, the proposed control method can proceed to (310) where the supply voltage settles back to an approximately DC initial value and then the pulse to turn the switching element on and turn off is changed to increase switch-on duration. The method (300) can then be repeated to gradually increase the switch-on duration until it is measured in the switch-off duration that the peak voltage of the sinusoidal voltage oscillation with a DC offset is greater than, for example, 2.6 times the initial supply voltage.

At (308) the method can include determining that when the peak voltage across the switching element becomes greater than the threshold (e.g., 2.6 times the initial supply voltage) the proposed control method can set the switch-on duration as the minimum switch-on duration required for ZVS and confirm that the switch-on duration does not become less than the minimum switch-on duration so that hard-switching at high switch voltage can be avoided.

At (312) the method can include operating the quasi-resonant inverter with the switch-on duration greater than or equal to the minimum switch-on duration. In this manner, the gate driver for the switching elements can initiate gate pulses in accordance with the determined duration and practical ZVS can be achieved.

Although specific features of various embodiments may be shown in some drawings and not in others, this is for convenience only. In accordance with the principles of the present disclosure, any feature of a drawing can be referenced and/or claimed in combination with any feature of any other drawing.

This written description uses examples for the disclosure, including the best mode, and also to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for evaluating a switching duration for zero-voltage switching of a quasi-resonant inverter in an induction cooktop, the method comprising:
providing a pulse to turn a switching element associated with a quasi-resonant inverter in an induction cooktop on and off for a switch-on duration and a switch-off duration;
determining a peak voltage across the switching element during the switch-off duration;
determining whether the peak voltage across the switching element is greater than a threshold;
when the peak voltage across the switching element is greater than the threshold, determining that the switch-on duration is sufficient for zero-voltage switching of the switching element associated with the quasi-resonant inverter.

2. The method of claim 1, wherein determining the switch-on duration is sufficient corresponds to determining that the switch-on duration is greater than or equal to a minimum duration required for zero-voltage switching.

3. The method of claim 1, wherein the threshold is determined based at least in part by a ratio of the peak voltage to the supply voltage.

4. The method of claim 3, wherein the threshold is determined to be about 2.6 times greater than the supply voltage.

5. The method of claim 1, wherein when the peak voltage across the switching element is less than a threshold, the switch-on duration is increased until it is determined that the peak voltage is greater than the threshold.

6. The method of claim 1, wherein the method further comprises operating the quasi-resonant inverter with zero-voltage switching based on the switch-on duration.

7. The method of claim 1, wherein the switching element comprises a semiconductor switch configured to permit a current flow in a first direction, and a diode coupled in anti-parallel with the semiconductor switch to block current flow in a first direction while allowing currents to flow in a second direction.

8. A control system for evaluating a zero-voltage switching condition of a quasi-resonant inverter in an induction cooktop, the control system configured to perform operations, the operations comprising:
providing a pulse to turn a switching element associated with the quasi-resonant inverter in an induction cooktop on and off for a switch-on duration and a switch-off duration;
determining a peak voltage across the switching element for the switch-off duration;
determining whether the peak voltage across the switching element is greater than a threshold;
when the peak voltage across the switching element is greater than the threshold, setting the switch-on duration as the minimum switch-on duration required for zero-voltage switching of the switching element associated with the quasi-resonant inverter.

9. The control system of claim 8, wherein the switching element comprises a semiconductor switch configured to permit a current flow in a first direction, and a diode coupled in anti-parallel with the semiconductor switch to block current flow in a first direction while allowing current to flow in a second direction.

10. The control system of claim 8, wherein the threshold is determined based at least in part by a ratio of the peak voltage to the supply voltage.

11. The control system of claim 8, wherein the threshold is determined to be about 2.6 times greater than the supply voltage.

12. The control system of claim 9, wherein the control system is further configured to operate the quasi-resonant inverter with the switch-on duration greater than or equal to the minimum switch-on duration required for zero voltage switching of the switching element.

13. A quasi-resonant inverter for use in an induction cooktop, the quasi-resonant inverter comprising:
a power source configured to supply power to the induction cooktop;
a quasi-resonant inverter comprising an induction heating coil configured to inductively heat a load with a magnetic field, a capacitor coupled to the induction heating coil, a switching element; and
one or more control devices wherein the one or more control devices configured to perform operations, the operations comprising providing a pulse to turn a switching element associated with the quasi-resonant inverter in an induction cooktop on and off for a switch-on duration and a switch-off duration, determining a peak voltage across the switching element in the switch-off duration, determining whether the peak voltage across the switching element is greater than a threshold, when the peak voltage across the switching element is greater than the threshold, determining that the switch-on duration is sufficient for zero-voltage switching of the switching element associated with the quasi-resonant inverter.

14. The quasi-resonant inverter of claim 13, wherein determining the switch-on duration is sufficient corresponds to determining that the switch-on duration is greater than or equal to a minimum switch-on duration required for zero-voltage switching.

15. The quasi-resonant inverter of claim 13, wherein the threshold is determined at least in part by a ratio of the peak voltage to the supply voltage.

16. The quasi-resonant inverter of claim 13, wherein the threshold is determined to be about 2.6 times greater than the supply voltage.

17. The quasi-resonant inverter of claim 13, wherein when the peak voltage across the switching element is less than the threshold, the switch-on duration is increased until it is determined that the peak voltage is greater than the threshold.

18. The quasi-resonant inverter of claim 13, wherein the inverter is configured as a resonant tank.

19. The quasi-resonant inverter as in claim 13, wherein the one or more control devices are configured to operate the quasi-resonant inverter with zero-voltage switching based on the switch-on duration.

20. The quasi-resonant inverter of claim 13, wherein the switching element comprises a semiconductor switch.
